(19) United States
(12) Patent Application Publication
(10) Pub. No.: US 2026/0361033 A1
(43) Pub. Date: Nov. 12, 2026

(54) Assemblies, Systems, and Methods Associated with a Socket Fitting Having Integrated Safety Shutoff Features

(71) Applicant: Parker-Hannifin Corporation, Cleveland, OH (US)

(72) Inventor: Michael Valenches, Glastonbury, CT (US)

(21) Appl. No.: 19/541,508

(22) Filed: Feb. 17, 2026

Related U.S. Application Data
(60) Provisional application No. 63/801,884, filed on May 8, 2025.

(51) Int. Cl. H01R 13/639; F16L 37/23; H01R 13/502; H01R 13/627

(52) U.S. Cl. CPC H01R 13/6395; F16L 37/23; H01R 13/502; H01R 13/6275; H01R 13/639

(57) ABSTRACT

An example a socket fitting includes a socket housing, a socket stem, a locking element, and a solenoid actuator having a plunger. The socket fitting operates in: (i) a first mode of operation when the solenoid actuator is in a first state and the plunger is in a first position, wherein the plunger causes the locking element to prevent movement of the socket stem relative to the socket housing, allowing fluid flow therethrough, and (ii) a second mode of operation when the solenoid actuator is in a second state causing the plunger to move to a second position, wherein the plunger causes the locking element to release the socket stem to move relative to the socket housing, thereby blocking fluid flow through the socket housing.

### CROSS REFERENCE TO RELATED APPLICATION

The present application claims priority to U.S. Provisional Patent Application No. 63/801,884, filed on May 8, 2025, the entire contents of which are herein incorporated by reference as if fully set forth in this description.

### BACKGROUND

A quick connect/disconnect coupling allows for quick and safe connecting and disconnecting of fluid lines in cooling systems. Conventional couplings require a tool (e.g., wrench) in order to tighten a nut into a threaded body of a fitting. This tightening process takes a long time, particularly when an application requires forming hundreds of such couplings.

For example, data center servers may have hundreds or thousands of fittings connected to server racks. Technicians then connect a respective fitting to each of the fittings of the server racks to provide coolant thereto. Having to thread hundreds or thousands of fittings via a torqueing wrench consumes a substantial amount of time, is not efficient, and may lead to technician fatigue. It may thus be desirable to provide a quick connect/disconnect coupling that alleviates such issues.

Further, if a leak occurs, the leaking coolant can cause damage. For example, in data centers that use coolant for thermal management of servers, there is a risk of equipment damage (e.g., damage to processors or other electronic components) in the event of a coolant leak. To minimize potential damage from such leaks, the current approach involves using either a single shutoff valve that controls coolant flow to an entire server rack (which contains multiple server trays) or individual shutoff valves for each server tray.

When employing a single server rack solenoid shutoff valve, a leak may require shutting down the entire server rack, which can lead to data loss and unnecessary downtime. In contrast, using separate shut off valves for each server tray allows for targeted shutdowns, isolating only the affected server in the event of a leak. However, this configuration introduces significant plumbing complexity and requires additional space to accommodate the extra hardware.

It may thus be desirable to have a configuration that targets specific server trays while reducing complexity and cost. It is with respect to these and other considerations that the disclosure made herein is presented.

### SUMMARY

The present disclosure describes implementations that relate to assemblies, systems, and methods associated with a socket fitting having integrated safety shutoff features.

In a first example implementation, the present disclosure describes a socket fitting. The socket fitting includes a socket housing, a socket stem, a locking element, and a solenoid actuator having a plunger. The socket fitting operates in: (i) a first mode of operation when the solenoid actuator is in a first state and the plunger is in a first position, wherein the plunger causes the locking element to prevent movement of the socket stem relative to the socket housing, allowing fluid flow therethrough, and (ii) a second mode of operation when the solenoid actuator is in a second state causing the plunger to move to a second position, wherein the plunger causes the locking element to release the socket stem to move relative to the socket housing, thereby blocking fluid flow.

In a second example implementation, the present disclosure also describes an assembly of the socket fitting of the first example implementation and a plug fitting that is inserted, at least partially within the socket fitting, wherein the plug fitting includes (i) a plug housing, and (ii) a plug stem disposed within the plug housing and contacting the socket stem. In the first mode of operation, fluid flow is allowed through the plug housing and the socket housing.

In a third example implementation, the present disclosure also describes a system including the assembly of the second example implementation.

In a fourth example implementation, the present disclosure also describes a method of forming the assembly of the second example implementation.

In a fifth example implementation, the present disclosure also describes a method of operating the assembly of the second example implementation or the system of the third example implementation.

The foregoing summary is illustrative only and is not intended to be in any way limiting. In addition to the illustrative aspects, implementations, and features described above, further aspects, implementations, and features will become apparent by reference to the figures and the following detailed description.

### BRIEF DESCRIPTION OF THE FIGURES

The novel features believed characteristic of the illustrative examples are set forth in the appended claims. The illustrative examples, however, as well as a preferred mode of use, further objectives and descriptions thereof, will best be understood by reference to the following detailed description of an illustrative example of the present disclosure when read in conjunction with the accompanying Figures.

FIG. 1 is a block diagram of a system, according to an example implementation.

FIG. 2A illustrates a side view of a socket fitting, according to an example implementation.

FIG. 2B illustrates a cross-sectional side view of the socket fitting of FIG. 2A, according to an example implementation.

FIG. 2C illustrates an enlarged cross-sectional side view of the socket fitting of FIGS. 2A-2B, according to an example implementation.

FIG. 2D illustrates a bottom cross-sectional view of the socket fitting of FIGS. 2A-2B, according to an example implementation.

FIG. 2E illustrates a bottom cross-sectional view of a socket fitting having a locking element configured as one or more pins, according to an example implementation.

FIG. 3 illustrates a partial cross-sectional view of a plug fitting, according to an example implementation.

FIG. 4A illustrates a cross-sectional view of the plug fitting of FIG. 3 aligned with the socket fitting of FIGS. 2A-2B prior to assembly, according to an example implementation.

FIG. 4B illustrates a cross-sectional view of the plug fitting of FIG. 3 inserted within the socket fitting of FIGS. 2A-2B to form an assembly, according to an example implementation.

FIG. 5A illustrates a cross-sectional view of the assembly of FIG. 4B with a solenoid actuator of the socket fitting in an actuated state, according to an example implementation.

FIG. 5B illustrates an enlarged cross-sectional view of the assembly of FIG. 5A, according to an example implementation.

FIG. 6 is a flowchart of a method for operating the assembly of FIGS. 4B, 5A or the system of FIG. 1, according to an example implementation.

### DETAILED DESCRIPTION

Within examples, disclosed herein is a socket fitting that features an integrated solenoid-actuated locking configuration. The socket fitting has a safety shutoff configuration that, in the event of a leak, allows for coolant flow to be shut off to a single server tray where the leak is detected, while minimizing the overall hardware and fluid connections required. The disclosed configurations enhance safety and simplify the cooling system architecture. Although the disclosed socket fitting is described in the context of data centers, it should be understood that the disclosed configurations can be used in any cooling systems that uses a socket fitting and safety shutoff features.

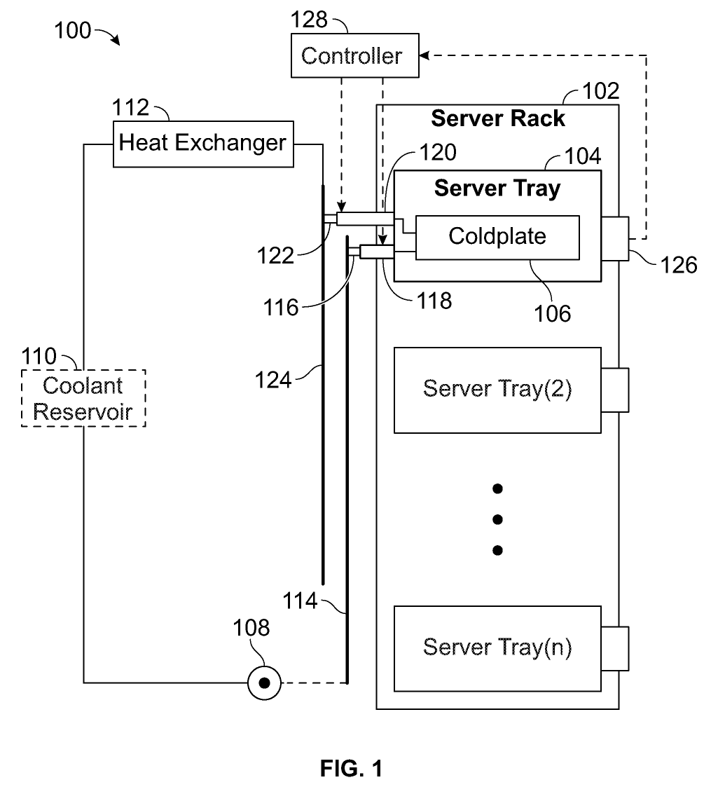

FIG. 1 is a block diagram of a system 100, according to an example. The system 100 can be used to cool a server rack 102, for example. The server rack 102 can include a plurality of server trays (e.g., “n” trays) such as server tray 104.

Each server tray used in data centers may include a chassis, or box-like structure, housing multiple thin, modular electronic circuit boards with electronic chips mounted thereto, for example. A cold plate such as cold plate 106 can be mounted in each server tray to facilitate cooling the server tray.

The term “electronic chip” is used herein to encompass the electronic components and a housing or container in which the electronic components are disposed. An electronic chip represents microprocessors, memory, application specific integrated circuits (ASIC), etc., as examples.

Such electronic chips generate a large amount of heat during operation. To protect the electronic chips and the server trays or the server rack 102 generally, it may be desirable to cool the server trays and reduce the operating temperatures of the electronic chips.

The electronic chips can be mounted to the cold plate 106 or the cold plate 106 can be mounted atop the electronic chips. The cold plate 106 is a component that cools the electronic chips and other electronics by transferring heat from such electronic components. Particularly, the cold plate 106 may be configured to have a large surface area to increase heat transfer from the electronic components to a coolant that flows through or near the cold plate 106. The terms “coolant” and “fluid” are used herein interchangeably. Example coolants include water, PG25 and PG55 propylene glycol coolants, refrigerants, a dielectric coolants (e.g., Paratherm LR, Slytherm 800, or Shell Diala), etc.

The system 100 includes a source 108 of coolant. The source 108 can be a pump for example. As such, the source 108 can be configured to operate as a positive pressure source of coolant that draws coolant from a coolant reservoir 110 and circulates the coolant throughout the server rack 102, a heat exchanger 112, the cold plates (e.g., the cold plate 106), etc.

For example, the system 100 can include a supply rail or supply manifold 114 that is fluidly coupled to the source 108 of coolant. The supply manifold 114 provides coolant through a coupling or assembly of a plug fitting and socket fitting to the individual server trays. For example, the supply manifold 114 provides coolant through a plug fitting 116 (coupled to the supply manifold 114) and a socket fitting 118 coupled to the server tray 104, then to the cold plate 106. Such coolant absorbs heat generated by the electronic components of the server tray 104 to cool them.

Heated coolant is then routed through a socket fitting 120 (mounted or coupled to the server tray 104) and a plug fitting 122 to a return manifold 124. Coolant is then routed to the heat exchanger 112 to be cooled. The socket fitting 120 and the plug fitting 122 are shown longer in FIG. 1 for illustration purposes only. In practice, the return manifold 124 may be parallel to the supply manifold 114, and thus the socket fitting 120 may be identical to the socket fitting 118, and the plug fitting 122 may be identical to the plug fitting 116.

The heat exchanger 112 can be a device that transfers thermal energy from the coolant returning from the server tray 104 to another fluid without the fluids directly mixing. The coolant reservoir 110 is optional, and in some examples, fluid from the heat exchanger 112 is provided directly to the source 108 of coolant. Fittings connected to the other server trays and associated connections are not shown to reduce visual clutter in the drawing, but it should be understood that similar fittings and connections are coupled to the other server trays and operate in a similar manner.

If coolant leaks from any fluid connection, fluid line, or component in the system 100, the electronic components of the server rack 102 may be damaged. To minimize potential damage from such leaks, a single shutoff valve that controls coolant flow to the entire server rack or individual shutoff valves for each server tray may be used.

When employing a single rack solenoid shutoff valve, a leak may require shutting down the entire server rack, which can lead to data loss and unnecessary downtime. In contrast, using separate valves for each server tray allows for targeted shutdowns, isolating only the affected server in the event of a leak. However, this configuration introduces significant plumbing complexity and requires additional space to accommodate the extra hardware.

The system 100 advantageously integrates such shut off features in the socket fitting (e.g., the socket fittings 118, 120). Particularly, the socket fittings 118, 120 each includes an integrated solenoid-actuated locking function that blocks coolant flow upon actuation.

Coolant leakage detection sensors, such as sensor 126, may be deployed throughout the server rack 102. For example, each server tray (e.g., the server tray 104) may have a respective sensor (e.g., the sensor 126) that detects coolant leakage within the respective server tray. The sensors can be located at one or more locations in the server tray. In other examples, the sensors can be mounted in or about the supply manifold 114 and/or the return manifold 124.

Example coolant leakage detection sensor may include moisture sensors (e.g., fiber optic humidity sensors). As coolant evaporates and humidity increases, the sensor can detect that the humidity or moisture level has exceeded a threshold value, and provide sensor information indicative to such moisture level. In another example, a wire or a rope sensor may be wrapped around or embedded within the supply manifold 114 and/or the return manifold 124. If a leakage occurs, such rope absorbs the coolant, thereby changing conductivity or capacitance of the rope. Such change provides an indication that a leakage has occurred.

In another example, a pressure sensor can be used to detect leakage. Such sensors are configured to detect changes in pressure, which can be an indicator of a coolant leak. In other examples, the sensors can include liquid leak detection cables capable of detecting the presence of a liquid, making them suitable for detecting coolant leaks. In yet another example, ultrasonic leak detectors could be used. Such devices may be configured to use sound waves to detect the high-frequency sound associated with a leak.

Regardless of the type of sensor, such coolant leakage detection sensors such as the sensor 126, provide sensor information indicative of whether a leak has occurred to a controller 128 of the system 100. The controller 128 has a microprocessor that can include one or more processors. A processor can include a general purpose processor or a special purpose processor (e.g., a digital signal processor, a graphics processor, or an application specific integrated circuit (ASIC) processor). A processor can be configured to execute computer-readable program instructions (CRPI) to perform the operations described throughout herein. A processor can be configured to execute hard-coded functionality in addition to or as an alternative to software-coded functionality (e.g., via CRPI).

The controller 128 monitors the system 100 to detect leakage based on the sensor information. If leakage is detected at a particular server tray, the controller 128 sends a command signal to a solenoid actuator of one or both of the socket fittings (e.g., one or both of the socket fittings 118, 120) of the particular tray to shut coolant flow off with respect to the particular tray. In some examples, the socket fitting 120 might be replaced with a check valve.

As such, the socket fitting serves as a safety shutoff valve in the event of a leak, allowing for the fluid flow to be shut off to a single server tray where the leak is detected, while minimizing the overall hardware and fluid connections required. No additional valves, associated fluid lines, fittings, etc. are required. This configuration enhances safety while simplifying the system 100.

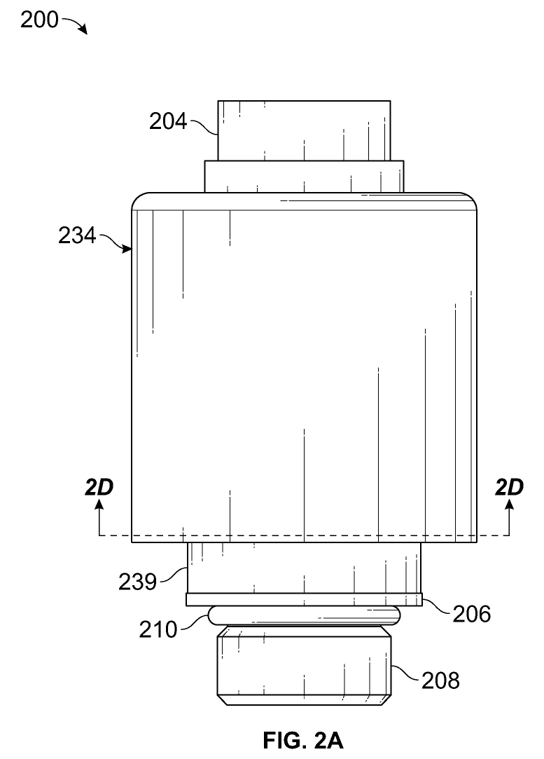

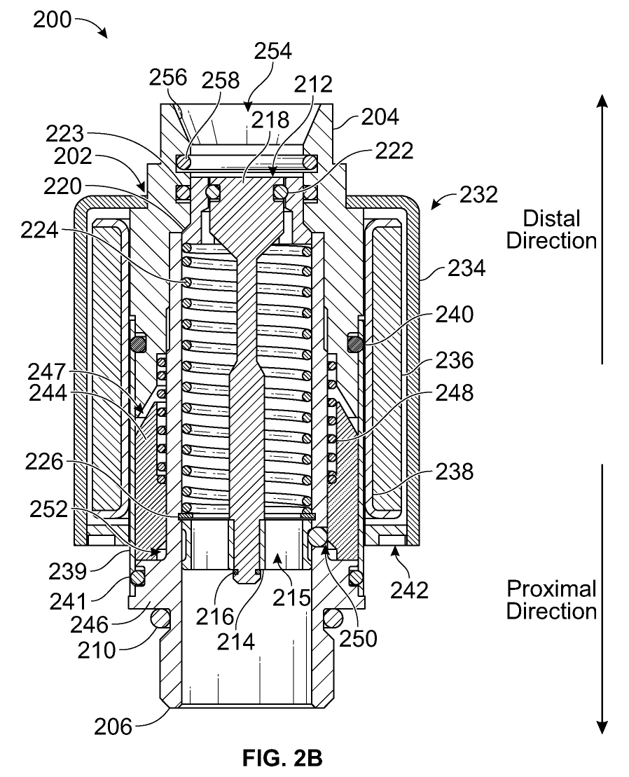

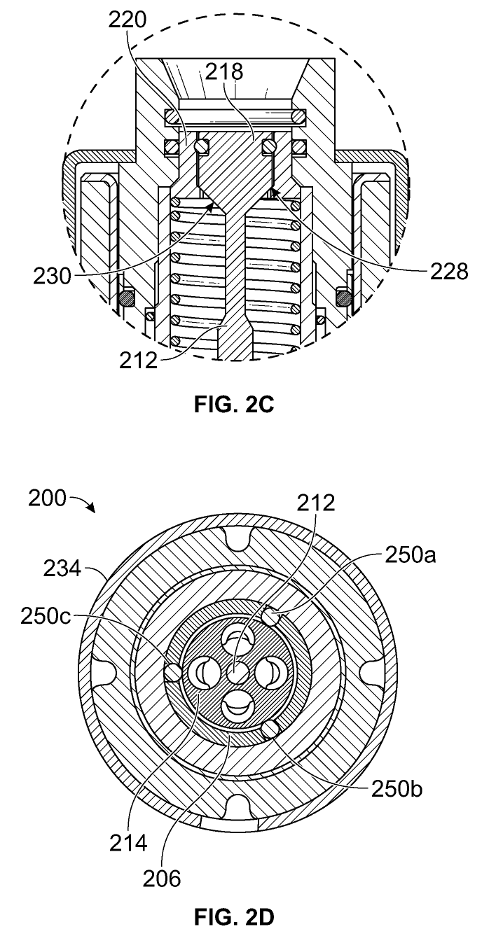

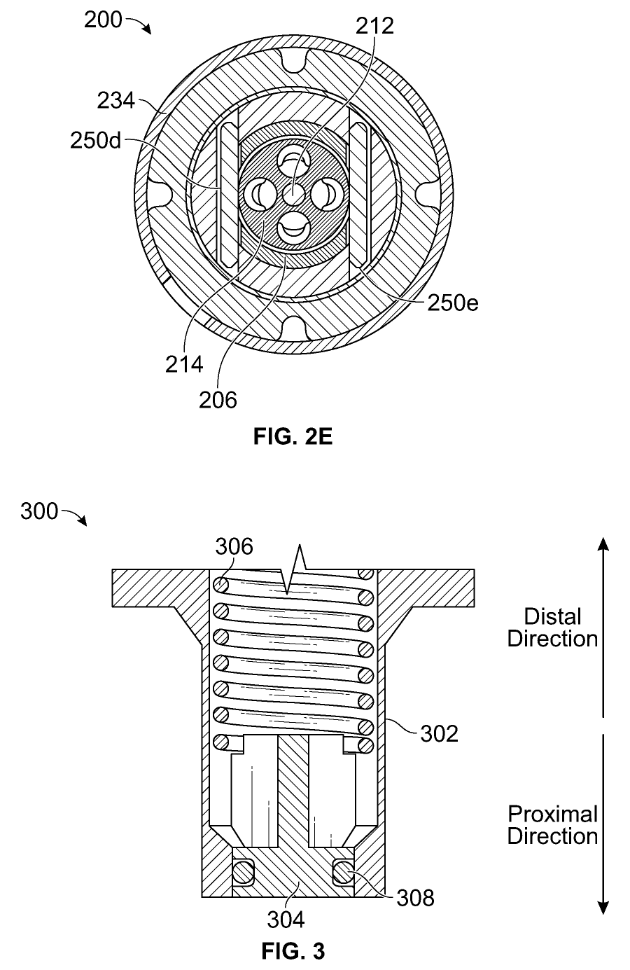

FIG. 2A illustrates a side view of a socket fitting 200, and FIG. 2B illustrates a cross-sectional side view of the socket fitting 200, according to an example implementation. The socket fitting 200 represents either of the socket fittings 118, 120, for example.

The socket fitting 200 includes a socket body or socket housing 202 that can include a first housing portion 204 (e.g., top housing portion in FIG. 2B) and a second housing portion 206 (e.g., bottom housing portion in FIG. 2B). The second housing portion 206 is configured as a tube disposed, at least partially, within the first housing portion 204.

The second housing portion 206 has a connection portion 208 that facilitates mounting the socket fitting 200 to the server tray, for example. As examples, the connection portion 208 can have threads to threadedly engage corresponding threads in the server tray, may have barbs to facilitate engaging the server tray, or may be configured as a straight O-ring boss (e.g., stud end), having O-ring 210 disposed thereabout to facilitate mounting the socket fitting 200 to a corresponding port in the server tray.

The first housing portion 204 and the second housing portion 206 form therein a longitudinal cavity in which a socket stem 212 is disposed and is linearly/axially movable. The socket stem 212 is coupled at its proximal end to a stem guide 214 via a locking ring 216. With this configuration, the socket stem 212 and the stem guide 214 can move axially together. The stem guide 214 has longitudinal holes such as hole 215 formed therein to facilitate flow of coolant therethrough.

The socket stem 212 has a stem head 218 having an enlarged diameter. The socket fitting 200 also has a collar 220 disposed within the first housing portion 204, and configured to cooperate with the stem head 218 to block fluid flow when the socket fitting 200 is in a closed position shown in FIG. 2B.

Particularly, in the closed position shown in FIG. 2B, a seal 222 (e.g., radial seal or O-ring) is disposed about the stem head 218 and seals between the stem head 218 and the collar 220. Another seal 223 is mounted between the collar 220 and the interior surface of the first housing portion 204.

The socket fitting 200 further includes a collar spring 224. A distal end of the collar spring 224 rests against the collar 220, while a proximal end of the collar spring 224 rests against a retaining ring 226 that is fixedly mounted to the second housing portion 206. With this configuration, the collar spring 224 applies a biasing force on the collar 220 in the distal direction.

Reference to “distal” and “proximal” herein is not intended to imply a specific orientation of components of the socket fitting 200 (or other components) relative to any surrounding environment. Instead, these directional terms are intended to facilitate a description of the interrelationship between the several components of the socket fitting 200 and their function.

The collar 220 is configured to move in the proximal direction freely, without affecting the socket stem 212. However, the collar 220 has engaging features that can engage with the socket stem 212 such that if the collar 220 moves in the distal direction, it moves the socket stem 212 therewith.

FIG. 2C illustrates an enlarged cross-sectional side view of the socket fitting 200, according to an example implementation. As shown, the collar 220 can have a conical protrusion 228 that mates with a conical portion 230 at a transition from a thin stem portion of the socket stem 212 to the stem head 218. With this configuration, the collar 220 can move in the proximal direction relative to the socket stem 212. However, if the collar 220 moves in the distal direction, it can engage the stem head 218, and thereby move the socket stem 212 in the distal direction therewith.

Referring back to FIG. 2B, the socket fitting 200 has a solenoid actuator 232 having a coil housing 234, a coil 236 (e.g., wire windings) disposed within the coil housing 234, and a coil bobbin 238 that retains and supports the coil 236. The coil bobbin 238 can be a cylindrical structure, made of non-conductive material, used to hold and secure the coil 236 during winding of its wires. The coil bobbin 238 provides structural support, helps maintain the shape of the coil 236, and also provides electrical isolation between windings of the coil 236. In one example, the coil windings of the coil 236 may be individually varnished to provide insulation between each winding.

The socket fitting 200 may further include a sleeve 239 that is mounted about the first housing portion 204. The coil bobbin 238 is mounted around the first housing portion 204 and the sleeve 239. The coil bobbin 238 may provide added insulation between the windings of the coil 234, and the sleeve 239 and the first housing portion 204. As shown, a seal 240 may be mounted between the sleeve 239 and the first housing portion 204. Another seal 241 may also be mounted between sleeve 239 and the second housing portion 206.

Further, the socket fitting 200 may further include a flux washer 242 mounted between the coil housing 234 and the sleeve 239. The flux washer 242 is part of the magnetic circuit, which includes the plunger 244, the first housing portion 204, and coil housing 234. These components are made from a magnetic steel material, for example. The sleeve 239 and the second housing portion 206 can be made of non-magnetic steel to force the magnetic flux to traverse the airgap (e.g., airgap 247 described below) between the plunger 244 and the first housing portion 204. Further, the flux washer 242, along with the coil housing 234, form an enclosure about the socket housing 202, where the coil 236 and the coil bobbin 238 are mounted within such enclosure.

The solenoid actuator 232 further includes an armature or plunger 244 that is disposed around at least a portion of the socket housing 202, and particularly around the second housing portion 206. That plunger 244 is also axially interposed between the first housing portion 204 and a flange 246 of the second housing portion 206. The plunger 244 is also retained by the sleeve 239 as depicted in FIG. 2B.

As shown, the plunger 244 has a slanted or tapered distal surface, and the first housing portion 204 has a corresponding tapered proximal surface such that a magnetic gap or airgap 247 is formed between the plunger 244 and the first housing portion 204 when the solenoid actuator 232 is unactuated (e.g., when the coil 236 is de-energized). The solenoid actuator 232 also includes a plunger spring 248 that is disposed around the second housing portion 206, and is axially interposed between the first housing portion 204 and an internal shoulder formed by the plunger 244. As the first housing portion 204 is fixed, the plunger spring 248 applies a biasing force on the plunger 244 in the proximal direction.

Further, the socket fitting 200 includes one or more locking elements such as locking element 250 that facilitates retaining the stem guide 214 (and the socket stem 212) at the axial position shown in FIG. 2B. Particularly, the stem guide 214 may have an exterior annular recess or groove in which the locking element 250 is partially disposed. The locking element 250 is also partially disposed in a hole or gap formed in the second housing portion 206. In the unactuated position shown in FIG. 2B, the plunger 244 retains the locking element 250 in place.

As such, the stem guide 214 is prevented by the locking element 250 from moving axially when the plunger 244 is in the unactuated position or state shown in FIG. 2B. However, the plunger 244 has an annular recess 252 that can receive the locking element 250 therein when the plunger 244 moves in the distal direction (when the coil 236 is energized as described below), thereby releasing the stem guide 214 and the socket stem 212 coupled thereto and allowing them to move axially. As the locking element 250 can move between the cavity in which the plunger 244 is disposed and the cavity in which the socket stem 212 is disposed, the cavity of the plunger 244 may be exposed to coolant pressure, and the sleeve 239 is configured to seal the coolant under pressure.

The locking element 250 can take several forms. For example, the locking element 250 can be one or more balls or pins.

FIG. 2D illustrates a bottom cross-sectional view of the socket fitting 200, according to an example implementation. The cross-sectional cutting plane of FIG. 2D is labelled in FIG. 2A. As shown in FIG. 2D, the second housing portion 206 may have several holes, (three in this example), and the locking element 250 can include one or more balls (e.g., similar to balls of a ball bearing) such as ball 250a, ball 250b, and ball 250c. More or fewer balls can be used.

Referring to FIGS. 2B, 2D together, when the plunger 244 is in the unactuated position of FIG. 2B, it traps the balls 250a-250c in their respective holes in the second housing portion 206, and partially within the exterior annular recess/groove of the stem guide 214. As such, the stem guide 214 is prevented from moving. However, if the plunger 244 moves in the distal direction when actuated, the balls 250a-250c can be pushed radially outward into the annular recess 252 of the plunger 244, thereby releasing the stem guide 214 and allowing it to move.

The locking element 250 can take other forms. For example, the locking element 250 can include on or more pins instead of balls.

FIG. 2E illustrates a bottom cross-sectional view of the socket fitting 200 having a locking element configured as one or more pins, according to an example implementation. As shown, the second housing portion 206 may have one or more channels, (two in this example), and the locking element 250 can include one or more pins such as pin 250d and pin 250e. More or fewer pins can be used. The pins 250d, 250e may operate in a similar manner to the balls 250a-250c to lock and release the stem guide 214. Particularly, the plunger 244 may have slots that respectively receive the pins 250d, 250e when the plunger 244 moves to the actuated position to release the stem guide 214 and the socket stem 212.

Referring back to FIG. 2B, the socket fitting 200 is configured to receive a plug fitting (e.g., the plug fitting 116, 122) therein to form a coupling and allow coolant flow therethrough. Particularly, the first housing portion 204 has a distal opening 254 through which the plug fitting can be inserted.

In an example the distal end of the first housing portion 204 can have a conical interior surface 256 that bounds the distal opening 254, wherein the conical interior surface 256 tapers outward as shown in FIG. 2B. This configuration facilitates insertion of the plug fitting even when there is misalignment therebetween. Further, as shown in FIG. 2B, the socket fitting 200 has a seal 258 (e.g., O-ring redial seal) that cooperates with the plug fitting to form a sealed connection therebetween and prevent coolant leakage when the plug fitting is inserted to the socket fitting 200.

FIG. 3 illustrates a partial cross-sectional view of a plug fitting 300, according to an example implementation. The plug fitting 300 represents either of the plug fittings 116, 122 of FIG. 1, for example.

The plug fitting 300 includes a plug body or plug housing 302. The plug fitting 300 also includes a plug stem 304 that is linearly movable within the plug housing 302.

The plug stem 304 is biased in the proximal direction by a plug stem spring 306. Particularly, the distal end of the plug stem spring 306 rests against the plug housing 302, and is thus fixed, while the proximal end of the plug stem spring 306 rests against the plug stem 304. With this configuration, the plug stem 304 is biased in the proximal direction. A seal 308 (e.g., an O-ring radial seal) is mounted in a groove formed in the head portion of the plug stem 304 and is configured to seal between the plug stem 304 and the plug housing 302.

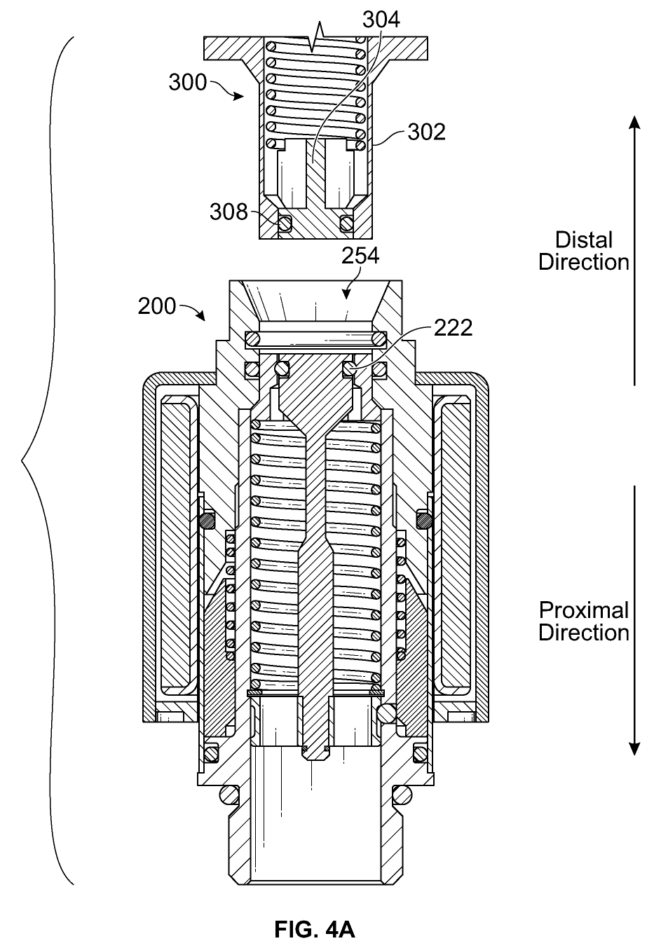

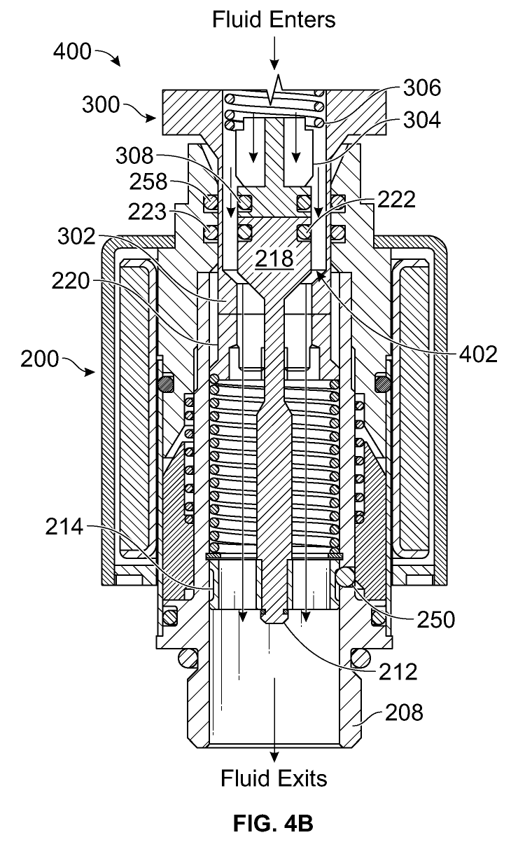

FIG. 4A illustrates a cross-sectional view of the plug fitting 300 aligned with the socket fitting 200 prior to assembly, and FIG. 4B illustrates a cross-sectional view of the plug fitting 300 inserted within the socket fitting 200 to form an assembly 400, according to an example implementation. In FIG. 4A, both the plug fitting 300 and the socket fitting 200 are in their closed state and no coolant is allowed to flow. The plug fitting 300 is aligned with the distal opening 254 of the socket fitting 200 in preparation for inserting the plug fitting 300 into the socket fitting 200 to form a coupling/assembly and allow coolant flow through such assembly.

FIG. 4B shows the coupling or the assembly 400 formed after insertion of the plug fitting 300 is inserted into the socket fitting 200. As shown, when the plug fitting 300 is inserted, the head portion of the plug stem 304 mates with or contacts the stem head 218 of the socket stem 212. The plug stem 304 cannot move further in the proximal direction as the socket stem 212 is prevented from moving in the proximal direction because of the interaction between the locking element 250 with the stem guide 214 (which is coupled to the socket stem 212) as the plunger 244 is in the unactuated position.

However, the plug housing 302 can continue to move in the proximal direction, and the plug stem spring 306 is compressed as a result. Further, as depicted in FIG. 4B, the plug housing 302 contacts the collar 220 of the socket fitting 200 and causes the collar 220 to move in the proximal direction as the plug housing 302 continues to move in the proximal direction. As such, the seal 308 of the plug stem 304 and the seal 222 between the collar 220 and the stem head 218 no longer mate with their seal surfaces.

As the socket stem 212 remains fixed in position, while the plug housing 302 and the collar 220 move relative to the socket stem 212, a flow area 402 is formed between the socket stem 212 and the plug housing 302. Thus, as indicated by the flow arrows, fluid enters into the plug fitting 300 (e.g., from the supply manifold 114) and flows in the proximal direction around the plug stem 304 and the socket stem 212, through the flow area 402, then through the collar 220 and the longitudinal cavity of the socket fitting 200, through the holes (e.g., the hole 215 in FIG. 2B) in the stem guide 214 and exits through the connection portion 208 of the socket fitting 200.

Notably, if the socket fitting 200 represents the socket fitting 120 and the plug fitting 300 represents the plug fitting 122, the direction of coolant flow is in reverse. Particularly, coolant enters through the connection portion 208, then flows through the socket fitting 200 and the plug fitting 300, then exits through the plug fitting 300 into the return manifold 124.

As described above with respect to FIG. 1, if a leakage occurs, components of the system 100 (e.g., electronic components) may be damaged. The controller 128 is configured to detect such leakage based on sensor information from the sensors (e.g., the sensor 126) disposed in the server rack 102, for example, and responsively energize the coil 236, causing the assembly 400 to block coolant flow therethrough and restrict further pressurized fluid flow between the server tray and the manifolds 114, 124.

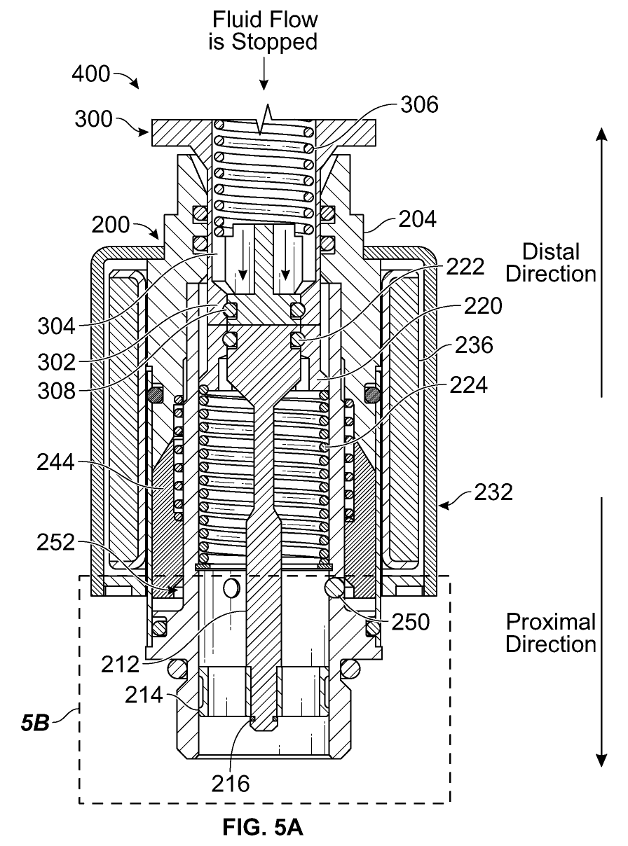

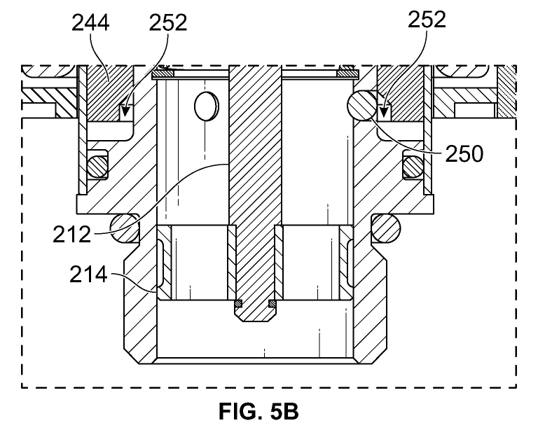

FIG. 5A illustrates a cross-sectional view of the assembly 400 with the solenoid actuator 232 of the socket fitting 200 in an actuated state, accordingly to an example implementation. Notably, the first housing portion 204 and the plunger 244 are composed of material of high magnetic permeability (e.g., magnetic steel).

To actuate the solenoid actuator 232, an electric command signal can be sent from the controller 128 to the coil 236. When an electrical current is provided through the windings of the coil 236, a magnetic field is generated. The first housing portion 204 directs the magnetic field through the airgap 247 (see FIG. 2B) toward the plunger 244, which is movable and is attracted toward the first housing portion 204.

In other words, when an electrical current flows through the coil 236, the generated magnetic field forms a north and south pole in the first housing portion 204 and the plunger 244, and therefore the first housing portion 204 and the plunger 244 are attracted to each other. Because the first housing portion 204 is fixed and the plunger 244 is movable, the plunger 244 can traverse the airgap 247 toward the first housing portion 204, and the airgap 247 is reduced or completely traversed by the plunger 244 as shown in FIG. 5A. As the plunger 244 moves in the distal direction, the annular recess 252 becomes aligned with the locking element 250.

FIG. 5B illustrates an enlarged cross-sectional view of the assembly 400 of FIG. 5A, according to an example implementation. Particularly, FIG. 5B shows the locking element 250 now aligned with the annular recess 252. As a result, the locking element 250 (e.g., the balls 250a-250c or the pins 250d-250e) are free to move radially outward to be received in the annular recess 252, thereby releasing the stem guide 214 and allowing it to move in the proximal direction.

As the stem guide 214 is free to move, the coolant pressure differential and the plug stem spring 306 acting on the plug stem 304, and thus acting on the socket stem 212, cause both the stem guide 214 and the socket stem 212 (which is coupled to the stem guide 214 via the locking ring 216) to move in the proximal direction to the position shown in FIG. 5A (compare the position of the socket stem 212 and the stem guide 214 in FIG. 5A to their position in FIG. 4B).

As such, the plug stem 304 moves to a sealing position, sealing via the seal 308 against the plug housing 302. Similarly, the socket stem 212 also moves to a sealing position, sealing via the seal 222 against the collar 220. As a result, coolant flow stops or is blocked.

While the coil 236 is still energized, the plug fitting 300 can be removed from the socket fitting 200 to stop providing coolant from the source 108 and the supply manifold 114. As the plug fitting 300 is being removed, under the load or biasing force of the collar spring 224, the collar 220 is pushed in the distal direction, pushing the socket stem 212 with it in the distal direction due to engagement of the conical protrusion 228 of the collar 220 with the conical portion 230 of the socket stem 212 as described above with respect to FIG. 2C. As such, the collar 220 and the socket stem 212 are returned to the closed state shown in FIGS. 2B, 4A.

Once the plug fitting 300 is fully removed from the socket fitting 200, the coil 236 can be de-energized. The plunger spring 248 can then push the plunger 244 back in the proximal direction to the position shown in FIGS. 2B, 4A where the plunger 244 again trap the locking element 250 in place, preventing movement of the stem guide 214. In this position, the socket fitting 200 is ready to receive the plug fitting 300 again once the source of leakage is identified and addressed.

The configuration of the socket fitting 200 may provide several advantages over existing configurations. Connection between the plug fitting 300 and the socket fitting 200 does not require torquing, but is rather a quick connect/disconnect coupling configuration. Particularly, a server tray (e.g., the server tray 104) or the manifold (either of the manifolds 114, 124) can be moved toward one another thereby inserting the plug fitting into the socket fitting, forming a coupling and allowing coolant flow, and vice versa (e.g., pulling the manifold or the server rack disconnects the fittings from each other). Further, the socket fitting 200 and the plug fitting 300 can be connected and disconnected under pressure in a “drip-free” manner.

Further, the socket fitting integrates an electrically-actuated (e.g., solenoid-actuated) shut off feature that stops coolant flow upon detecting leakage. This allows the controller 128 to target and isolate a particular server tray for shut off, while allowing coolant to circulate through the other server trays. Further, with the disclosed configuration having the shut off feature integrated into the socket fitting 200, no additional, separate shut off valves are used for a particular server tray. This reduces costs and plumbing complexity, while enhancing reliability of the system by reducing the number of potential leak points and connections, and eliminating the likelihood of failure of such additional valves.

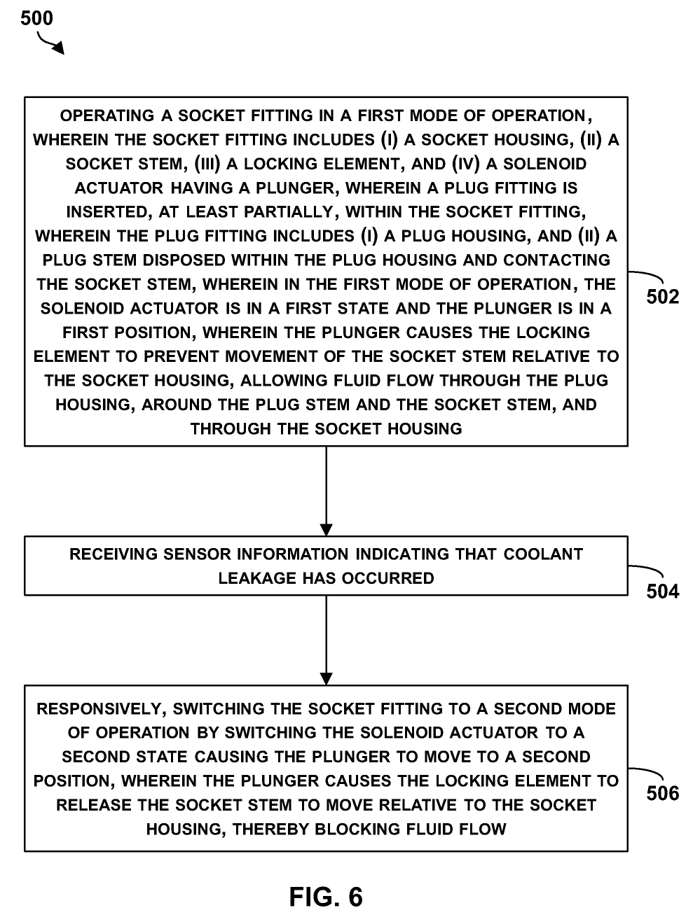

FIG. 6 is a flowchart of a method 500 for operating the assembly 400 or the system 100, according to an example implementation. The method 500 can be implemented, at least partially, by the controller 128 to control operation of the system 100 and/or the assembly 400, for example.

The method 500 may include one or more operations, or actions as illustrated by one or more of blocks 502-506. Although the blocks are illustrated in a sequential order, these blocks may in some instances be performed in parallel, and/or in a different order than those described herein. Also, the various blocks may be combined into fewer blocks, divided into additional blocks, and/or removed based upon the desired implementation.

In addition, for the method 500 and other processes and operations disclosed herein, the flowchart shows operation of one possible implementation of present examples. In this regard, each block may represent a module, a segment, or a portion of program code, which includes one or more instructions executable by a processor of the controller 128 for implementing specific logical operations or steps in the process. The program code may be stored on any type of computer readable medium or memory, for example, such as a storage device including a disk or hard drive. The computer readable medium may include a non-transitory computer readable medium or memory, for example, such as computer-readable media that stores data for short periods of time like register memory, processor cache and Random Access Memory (RAM). The computer readable medium may also include non-transitory media or memory, such as secondary or persistent long term storage, like read only memory (ROM), optical or magnetic disks, compact-disc read only memory (CD-ROM), for example. The computer readable media may also be any other volatile or non-volatile storage systems. The computer readable medium may be considered a computer readable storage medium, a tangible storage device, or other article of manufacture, for example. In addition, for the method 500 and other processes and operations disclosed herein, one or more blocks in FIG. 5 may represent circuitry or digital logic that is arranged to perform the specific logical operations in the process.

At block 502, the method 500 includes operating the socket fitting 200 in a first mode of operation (see FIG. 4B), wherein the socket fitting 200 includes (i) the socket housing 202, (ii) the socket stem 212, (iii) the locking element 250, and (iv) the solenoid actuator 232 having the plunger 244, wherein the plug fitting 300 is inserted, at least partially, within the socket fitting 200, wherein the plug fitting 300 includes (i) the plug housing 302, and (ii) the plug stem 304 disposed within the plug housing 302 and contacting the socket stem 212, wherein in the first mode of operation, the solenoid actuator 232 is in a first state (e.g., unactuated state) and the plunger 244 is in a first position (e.g., unactuated position), wherein the plunger 244 causes the locking element 250 to prevent movement of the socket stem 212 relative to the socket housing 202, allowing fluid flow through the plug housing 302, around the plug stem 304 and the socket stem 212, and through the socket housing 202.

At block 504, the method 500 includes receiving sensor information (e.g., from the sensor 126) indicating that coolant leakage has occurred.

At block 506, the method 500 includes, responsively, switching the socket fitting 200 to a second mode of operation (see FIG. 5A) by switching the solenoid actuator 232 to a second state (e.g., actuated state) causing the plunger 244 to move to a second position (e.g., actuated position), wherein the plunger 244 causes the locking element 250 to release the socket stem 212 to move relative to the socket housing 202, thereby blocking fluid flow.

The method 500 can further include any of the steps described throughout herein. For example, while the solenoid actuator is in the second state, the plug fitting is removed from the socket fitting, wherein the socket fitting further comprises a collar and a collar spring, wherein upon removing the plug fitting, the collar spring pushes the collar, causing the collar to engage the socket stem and move the socket stem therewith. Once the plug fitting is removed from the socket fitting, the controller 128 switches the solenoid actuator 232 back to the first state, thereby causing the plunger 244 to move back to the first position, causing the locking element 250 to prevent the socket stem 212 from moving.

The detailed description above describes various features and operations of the disclosed systems with reference to the accompanying figures. The illustrative implementations described herein are not meant to be limiting. Certain aspects of the disclosed systems can be arranged and combined in a wide variety of different configurations, all of which are contemplated herein.

Further, unless context suggests otherwise, the features illustrated in each of the figures may be used in combination with one another. Thus, the figures should be generally viewed as component aspects of one or more overall implementations, with the understanding that not all illustrated features are necessary for each implementation.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Further, devices or systems may be used or configured to perform actuators presented in the figures. In some instances, components of the devices and/or systems may be configured to perform the actuators such that the components are actually configured and structured (with hardware and/or software) to enable such performance. In other examples, components of the devices and/or systems may be arranged to be adapted to, capable of, or suited for performing the actuators, such as when operated in a specific manner.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

The arrangements described herein are for purposes of example only. As such, those skilled in the art will appreciate that other arrangements and other elements (e.g., machines, interfaces, operations, orders, and groupings of operations, etc.) can be used instead, and some elements may be omitted altogether according to the desired results. Further, many of the elements that are described are functional entities that may be implemented as discrete or distributed components or in conjunction with other components, in any suitable combination and location.

While various aspects and implementations have been disclosed herein, other aspects and implementations will be apparent to those skilled in the art. The various aspects and implementations disclosed herein are for purposes of illustration and are not intended to be limiting, with the true scope being indicated by the following claims, along with the full scope of equivalents to which such claims are entitled. Also, the terminology used herein is for the purpose of describing particular implementations only, and is not intended to be limiting.

Embodiments of the present disclosure can thus relate to one of the enumerated example embodiments (EEEs) listed below.

EEE 1 is an assembly comprising: a plug fitting having (i) a plug housing, and (ii) a plug stem disposed within the plug housing; and a socket fitting that receives a portion of the plug fitting therein, wherein the socket fitting includes (i) a socket housing, (ii) a socket stem that contacts the plug stem of the plug fitting, (iii) a locking element, and (iv) a solenoid actuator having a plunger, wherein the socket fitting operates in: (i) a first mode of operation when the solenoid actuator is in a first state and the plunger is in a first position, wherein the plunger causes the locking element to prevent movement of the socket stem relative to the socket housing, allowing fluid flow through the plug housing and the socket housing, and (ii) a second mode of operation when the solenoid actuator is in a second state causing the plunger to move to a second position, wherein the plunger causes the locking element to release the socket stem to move relative to the socket housing, thereby blocking fluid flow through the assembly.

EEE 2 is the assembly of EEE 1, wherein the solenoid actuator further comprises a coil, wherein in the first state, the coil is de-energized, and wherein in the second state, the coil is energized, causing the plunger to move and release the locking element.

EEE 3 is the assembly of EEE 2, wherein the locking element comprise a ball or pin, wherein in the first mode of operation, the plunger traps the ball or pin in place, wherein the ball or pin engages the socket stem and prevents the socket stem from moving.

EEE 4 is the assembly of EEE 3, wherein the plunger comprises an annular recess or slot, wherein in the second mode of operation, the plunger moves such that the annular recess or slot is aligned with the ball or pin, allowing the ball or pin to be received within the annular recess or slot and release the socket stem.

EEE 5 is the assembly of any of EEEs 1-4, wherein the socket fitting further comprises: a collar disposed within the socket housing, wherein the socket stem is partially disposed within the collar, wherein in the first mode of operation, when the plug stem is inserted into the socket fitting, the plug housing contacts and pushes the collar relative to the socket stem, which is prevented from moving via the locking element, thereby forming a flow area around the socket stem and allowing fluid flow.

EEE 6 is the assembly of EEE 5, wherein in the second mode of operation, when the socket stem is released, the socket stem moves to a position at which the socket stem seals against the collar.

EEE 7 is the assembly of any of EEEs 1-6, wherein the plunger is disposed around a portion of the socket housing and is movable axially around the socket housing.

EEE 8 is the assembly of EEE 7, wherein the socket housing comprises: a first housing portion having an opening that receives the plug fitting partially therethrough; and a second housing portion, wherein the plunger is disposed around the second housing portion such that an airgap is formed between the plunger and the first housing portion, wherein in the second state, the plunger has traversed the airgap toward the second housing portion, releasing the locking element.

EEE 9 is the assembly of any of EEEs 1-8, wherein the socket fitting further comprises: a stem guide coupled to the socket stem, wherein in the first mode of operation, the locking element engages the stem guide and prevents the stem guide and the socket stem coupled thereto from moving, and wherein in the second mode of operation, the locking element releases the stem guide, allowing the stem guide and the socket stem to move.

EEE 10 is the assembly of any of EEEs 1-9, wherein the plug fitting further comprises: a plug stem spring applying a biasing force on the plug stem toward the socket stem, wherein in the second mode of operation, as the socket stem is released from the locking element and is allowed to move, the plug stem spring causes the plug stem to move, thereby moving the socket stem therewith, and seal against the plug housing, blocking fluid flow.

EEE 11 is a system comprising: a server rack having a plurality of server trays; a supply manifold that is fluidly coupled to a source of coolant; the plug fitting of the assembly of any of EEEs 1-10 mounted to the supply manifold. For example, the plug fitting includes (i) a plug housing, and (ii) a plug stem disposed within the plug housing. The system also includes the socket fitting of the assembly of any of EEEs 1-10 mounted to a server tray of the plurality of server trays, wherein the plug fitting is inserted, at least partially, within the socket fitting. For example, the socket fitting includes (i) a socket housing, (ii) a socket stem that contacts the plug stem of the plug fitting, (iii) a locking element, and (iv) a solenoid actuator having a plunger, wherein the socket fitting operates in a first mode of operation when the solenoid actuator is in a first state and the plunger is in a first position, wherein the plunger causes the locking element to prevent movement of the socket stem relative to the socket housing, allowing fluid flow from the supply manifold through the plug housing and the socket housing to the server tray to cool the server tray. The system also includes a sensor configured to detect coolant leakage; and a controller performing operations comprising: receiving sensor information from the sensor indicting that coolant leakage has occurred, and responsively, switching the socket fitting to a second mode of operation by switching the solenoid actuator to a second state causing the plunger to move to a second position, wherein the plunger causes the locking element to release the socket stem to move relative to the socket housing, thereby blocking fluid flow through the assembly.

EEE 12 is the system of EEE 11, wherein the solenoid actuator further comprises a coil, wherein in the first state, the coil is de-energized, and wherein in the second state, the controller energizes the coil, causing the plunger to move and release the locking element.

EEE 13 is the system of EEE 12, wherein the locking element comprise a ball or pin, wherein in the first mode of operation, the plunger traps the ball or pin in place, wherein the ball or pin engages the socket stem and prevents the socket stem from moving, wherein the plunger comprises an annular recess or slot, wherein in the second mode of operation, the plunger moves such that the annular recess or slot is aligned with the ball or pin, allowing the ball or pin to be received within the annular recess or slot and release the socket stem.

EEE 14 is the system of any of EEEs 11-13, wherein the socket fitting further comprises: a collar disposed within the socket housing, wherein the socket stem is partially disposed within the collar, wherein in the first mode of operation, when the plug stem is inserted into the socket fitting, the plug housing contacts and pushes the collar relative to the socket stem, which is prevented from moving via the locking element, thereby forming a flow area around the socket stem and allowing fluid flow, and wherein in the second mode of operation, when the socket stem is released, the socket stem moves to a position at which the socket stem seals against the collar.

EEE 15 is the system of any of EEEs 11-14, wherein the socket housing comprises: a first housing portion having an opening that receives the plug fitting partially therethrough; and a second housing portion, wherein the plunger is disposed around the second housing portion such that an airgap is formed between the plunger and the first housing portion, wherein in the second state, the plunger has traversed the airgap toward the second housing portion, releasing the locking element.

EEE 16 is the system of any of EEEs 11-15, wherein the socket fitting further comprises: a stem guide coupled to the socket stem, wherein in the first mode of operation, the locking element engages the stem guide and prevents the stem guide and the socket stem coupled thereto from moving, and wherein in the second mode of operation, the locking element releases the stem guide, allowing the stem guide and the socket stem to move.

EEE 17 is the system of any of EEEs 11-16, wherein the plug fitting further comprises: a plug stem spring applying a biasing force on the plug stem toward the socket stem, wherein in the second mode of operation, as the socket stem is released from the locking element and is allowed to move, the plug stem spring causes the plug stem to move, thereby moving the socket stem therewith, and seal against the plug housing, blocking fluid flow.

EEE 18 is a method of operating the assembly of any of EEEs 1-10 or the system of any of EEEs 11-17. For example, the method includes: operating a socket fitting in a first mode of operation, wherein the socket fitting includes (i) a socket housing, (ii) a socket stem, (iii) a locking element, and (iv) a solenoid actuator having a plunger, wherein a plug fitting is inserted, at least partially, within the socket fitting, wherein the plug fitting includes (i) a plug housing, and (ii) a plug stem disposed within the plug housing and contacting the socket stem, wherein in the first mode of operation, the solenoid actuator is in a first state and the plunger is in a first position, wherein the plunger causes the locking element to prevent movement of the socket stem relative to the socket housing, allowing fluid flow through the plug housing and through the socket housing; receiving sensor information indicating that coolant leakage has occurred; and responsively, switching the socket fitting to a second mode of operation by switching the solenoid actuator to a second state causing the plunger to move to a second position, wherein the plunger causes the locking element to release the socket stem to move relative to the socket housing, thereby blocking fluid flow through the socket housing.

EEE 19 is the method of EEE 18, further comprising: while the solenoid actuator is in the second state, removing the plug fitting from the socket fitting, wherein the socket fitting further comprises a collar and a collar spring, wherein upon removing the plug fitting, the collar spring pushes the collar, causing the collar to engage the socket stem and move the socket stem therewith.

EEE 20 is the method of EEE 19, further comprising: once the plug fitting is removed from the socket fitting, switching the solenoid actuator back to the first state, thereby causing the plunger to move back to the first position, causing the locking element to prevent the socket stem from moving.

EEE 21 is the socket fitting of the assembly of any of EEEs 1-10, the system of any of EEEs 11-17, or the method of any of EEEs 18-20. For example, the socket fitting includes a socket housing, a socket stem, a locking element, and a solenoid actuator having a plunger. The socket fitting operates in: (i) a first mode of operation when the solenoid actuator is in a first state and the plunger is in a first position, wherein the plunger causes the locking element to prevent movement of the socket stem relative to the socket housing, allowing fluid flow therethrough, and (ii) a second mode of operation when the solenoid actuator is in a second state causing the plunger to move to a second position, wherein the plunger causes the locking element to release the socket stem to move relative to the socket housing, thereby blocking fluid flow through the assembly.

What is claimed is:

1. An assembly comprising:
a plug fitting having (i) a plug housing, and (ii) a plug stem disposed within the plug housing; and
a socket fitting that receives a portion of the plug fitting therein, wherein the socket fitting includes (i) a socket housing, (ii) a socket stem that contacts the plug stem of the plug fitting, (iii) a locking element, and (iv) a solenoid actuator having a plunger,
wherein the socket fitting operates in: (i) a first mode of operation when the solenoid actuator is in a first state and the plunger is in a first position, wherein the plunger causes the locking element to prevent movement of the socket stem relative to the socket housing, allowing fluid flow through the plug housing and the socket housing, and (ii) a second mode of operation when the solenoid actuator is in a second state causing the plunger to move to a second position, wherein the plunger causes the locking element to release the socket stem to move relative to the socket housing, thereby blocking fluid flow through the assembly.

2. The assembly of claim 1, wherein the solenoid actuator further comprises a coil, wherein in the first state, the coil is de-energized, and wherein in the second state, the coil is energized, causing the plunger to move and release the locking element.

3. The assembly of claim 2, wherein the locking element comprise a ball or pin, wherein in the first mode of operation, the plunger traps the ball or pin in place, wherein the ball or pin engages the socket stem and prevents the socket stem from moving.

4. The assembly of claim 3, wherein the plunger comprises an annular recess or slot, wherein in the second mode of operation, the plunger moves such that the annular recess or slot is aligned with the ball or pin, allowing the ball or pin to be received within the annular recess or slot and release the socket stem.

5. The assembly of claim 1, wherein the socket fitting further comprises:
a collar disposed within the socket housing, wherein the socket stem is partially disposed within the collar, wherein in the first mode of operation, when the plug stem is inserted into the socket fitting, the plug housing contacts and pushes the collar relative to the socket stem, which is prevented from moving via the locking element, thereby forming a flow area around the socket stem and allowing fluid flow.

6. The assembly of claim 5, wherein in the second mode of operation, when the socket stem is released, the socket stem moves to a position at which the socket stem seals against the collar.

7. The assembly of claim 1, wherein the plunger is disposed around a portion of the socket housing and is movable axially around the socket housing.

8. The assembly of claim 7, wherein the socket housing comprises:
a first housing portion having an opening that receives the plug fitting partially therethrough; and
a second housing portion, wherein the plunger is disposed around the second housing portion such that an airgap is formed between the plunger and the first housing portion, wherein in the second state, the plunger has traversed the airgap toward the second housing portion, releasing the locking element.

9. The assembly of claim 1, wherein the socket fitting further comprises:
a stem guide coupled to the socket stem, wherein in the first mode of operation, the locking element engages the stem guide and prevents the stem guide and the socket stem coupled thereto from moving, and wherein in the second mode of operation, the locking element releases the stem guide, allowing the stem guide and the socket stem to move.

10. The assembly of claim 1, wherein the plug fitting further comprises:
a plug stem spring applying a biasing force on the plug stem toward the socket stem, wherein in the second mode of operation, as the socket stem is released from the locking element and is allowed to move, the plug stem spring causes the plug stem to move, thereby moving the socket stem therewith, and seal against the plug housing, blocking fluid flow.

11. A system comprising:
a server rack having a plurality of server trays;
a supply manifold that is fluidly coupled to a source of coolant;
a plug fitting that is mounted to the supply manifold, wherein the plug fitting includes (i) a plug housing, and (ii) a plug stem disposed within the plug housing;
a socket fitting that is mounted to a server tray of the plurality of server trays, wherein the plug fitting is inserted, at least partially, within the socket fitting, wherein the socket fitting includes (i) a socket housing, (ii) a socket stem that contacts the plug stem of the plug fitting, (iii) a locking element, and (iv) a solenoid actuator having a plunger, wherein the socket fitting operates in a first mode of operation when the solenoid actuator is in a first state and the plunger is in a first position, wherein the plunger causes the locking element to prevent movement of the socket stem relative to the socket housing, allowing fluid flow from the supply manifold through the plug housing and the socket housing to the server tray to cool the server tray;
a sensor configured to detect coolant leakage; and
a controller performing operations comprising:
receiving sensor information from the sensor indicting that coolant leakage has occurred, and
responsively, switching the socket fitting to a second mode of operation by switching the solenoid actuator to a second state causing the plunger to move to a second position, wherein the plunger causes the locking element to release the socket stem to move relative to the socket housing, thereby blocking fluid flow through the assembly.

12. The system of claim 11, wherein the solenoid actuator further comprises a coil, wherein in the first state, the coil is de-energized, and wherein in the second state, the controller energizes the coil, causing the plunger to move and release the locking element.

13. The system of claim 12, wherein the locking element comprise a ball or pin, wherein in the first mode of operation, the plunger traps the ball or pin in place, wherein the ball or pin engages the socket stem and prevents the socket stem from moving, wherein the plunger comprises an annular recess or slot, wherein in the second mode of operation, the plunger moves such that the annular recess or slot is aligned with the ball or pin, allowing the ball or pin to be received within the annular recess or slot and release the socket stem.

14. The system of claim 11, wherein the socket fitting further comprises:
a collar disposed within the socket housing, wherein the socket stem is partially disposed within the collar, wherein in the first mode of operation, when the plug stem is inserted into the socket fitting, the plug housing contacts and pushes the collar relative to the socket stem, which is prevented from moving via the locking element, thereby forming a flow area around the socket stem and allowing fluid flow, and wherein in the second mode of operation, when the socket stem is released, the socket stem moves to a position at which the socket stem seals against the collar.

15. The system of claim 11, wherein the socket housing comprises:
a first housing portion having an opening that receives the plug fitting partially therethrough; and
a second housing portion, wherein the plunger is disposed around the second housing portion such that an airgap is formed between the plunger and the first housing portion, wherein in the second state, the plunger has traversed the airgap toward the second housing portion, releasing the locking element.

16. The system of claim 11, wherein the socket fitting further comprises:
a stem guide coupled to the socket stem, wherein in the first mode of operation, the locking element engages the stem guide and prevents the stem guide and the socket stem coupled thereto from moving, and wherein in the second mode of operation, the locking element releases the stem guide, allowing the stem guide and the socket stem to move.

17. The system of claim 11, wherein the plug fitting further comprises:
a plug stem spring applying a biasing force on the plug stem toward the socket stem, wherein in the second mode of operation, as the socket stem is released from the locking element and is allowed to move, the plug stem spring causes the plug stem to move, thereby moving the socket stem therewith, and seal against the plug housing, blocking fluid flow.

18. A method comprising:
operating a socket fitting in a first mode of operation, wherein the socket fitting includes (i) a socket housing, (ii) a socket stem, (iii) a locking element, and (iv) a solenoid actuator having a plunger, wherein a plug fitting is inserted, at least partially, within the socket fitting, wherein the plug fitting includes (i) a plug housing, and (ii) a plug stem disposed within the plug housing and contacting the socket stem, wherein in the first mode of operation, the solenoid actuator is in a first state and the plunger is in a first position, wherein the plunger causes the locking element to prevent movement of the socket stem relative to the socket housing, allowing fluid flow through the plug housing and the socket housing;
receiving sensor information indicating that coolant leakage has occurred; and
responsively, switching the socket fitting to a second mode of operation by switching the solenoid actuator to a second state causing the plunger to move to a second position, wherein the plunger causes the locking element to release the socket stem to move relative to the socket housing, thereby blocking fluid flow through the socket housing.

19. The method of claim 18, further comprising:
while the solenoid actuator is in the second state, removing the plug fitting from the socket fitting, wherein the socket fitting further comprises a collar and a collar spring, wherein upon removing the plug fitting, the collar spring pushes the collar, causing the collar to engage the socket stem and move the socket stem therewith.

20. The method of claim 19, further comprising:
once the plug fitting is removed from the socket fitting, switching the solenoid actuator back to the first state, thereby causing the plunger to move back to the first position, causing the locking element to prevent the socket stem from moving.
